(19) United States
(12) Patent Application Publication
(10) Pub. No.: US 2025/0233215 A1
(43) Pub. Date: Jul. 17, 2025

(54) WATER AND ACID ADSORBING BATTERY SEPARATOR AND PREPARATION METHOD THEREFOR, WATER AND ACID ADSORBING ELECTRODE PLATE, AND BATTERY

(71) Applicants: Tsinghua University, Beijing (CN); Beijing Vfortune New Energy Power Technology Development Co., Ltd., Beijing (CN)

(72) Inventors: Xiangming He, Beijing (CN); Li Sheng, Beijing (CN)

(73) Assignees: Tsinghua University, Beijing (CN); Beijing Vfortune New Energy Power Technology Development Co., Ltd., Beijing (CN)

(21) Appl. No.: 19/112,523

(22) PCT Filed: Sep. 20, 2023
(86) PCT No.: PCT/CN2023/119949

§ 371 Date: Mar. 17, 2025

(30) Foreign Application Priority Data
Sep. 20, 2022 (CN) 202211145859.2
Sep. 20, 2022 (CN) 202222492408.8

(51) Int. Cl. H01M 10/42; H01M 4/62; H01M 50/403; H01M 50/411; H01M 50/449; H01M 50/489

(52) U.S. Cl. CPC H01M 10/4235; H01M 4/62; H01M 50/403; H01M 50/411; H01M 50/449; H01M 50/489

(57) ABSTRACT

Provided are a water and acid adsorbing battery separator and a preparation method therefor, a water and acid adsorbing electrode plate, and a battery. A metal organic framework material is used and scrape-coated on a battery separator to prepare a composite separator, which can efficiently adsorb impurities such as water/acid from a battery, as a water and acid adsorbing battery separator. In one aspect, the water and acid adsorbing battery separator can effectively improve the cycling stability of a battery by adsorbing impurities such as water and an acid from the battery. In another aspect, the water and acid adsorbing battery separator can reduce control conditions of water during a battery assembly process, thereby effectively reducing the cost.

### RELATED APPLICATION

This application claims the priority of the Chinese patent application filed on Sep. 20, 2022, with application number 202211145859.2, entitled “A water and acid adsorbing battery separator and preparation method therefor, water and acid adsorbing electrode plate, and battery”, and claims the priority of the Chinese patent application filed on Sep. 20, 2022, with application number 202222492408.8, entitled “Battery composite separator and battery”, the original texts of which are hereby incorporated by reference.

### TECHNICAL FIELD

The embodiments of the present invention relate to the field of battery technology, and in particular to a water and acid adsorbing battery separator and a preparation method therefor, a water and acid adsorbing electrode plate, and a battery.

### BACKGROUND

The electrolyte of the battery easily absorbs water vapor in the air, which decomposes to produce acidic substances, causing the battery cycling performance to decay continuously. Therefore, lithium battery assembly generally needs to be in a very dry environment, such as a drying room or a glove box.

However, it is difficult to completely eliminate the trace amounts of water and hydrogen fluoride in the electrolyte. The trace amounts of water and acid currently present in the battery have great impact on the battery performance, especially the battery performance decay of the high nickel positive electrode. In addition, it costs a lot to strictly control the water content during the battery assembly process, including the electrolyte preparation process.

Therefore, how to control the water content of the battery to improve the battery cycling performance has become a technical problem that technicians in this field need to solve urgently.

### SUMMARY

### Technical Problem

The technical problem solved by the embodiments of the present invention is how to control the water content of the battery to improve the battery cycling performance.

### Technical Solution

In one aspect, an embodiment of the present invention provides a water and acid adsorbing battery separator, comprising a base film and a metal organic framework material, wherein the metal organic framework material is dispersed on at least one surface of the base film.

Optionally, the specific surface area of the metal organic framework material is >900 m²/g, and preferably, the specific surface area of the metal organic framework material is >2400 m²/g.

Optionally, the pore size of the metal organic framework material ranges from 0.92 nm to 3.5 nm.

Optionally, the water and acid adsorbing battery separator comprises a separator body and a metal organic framework material layer, wherein the separator body is composed of the base film, the metal organic framework layer is composed of the metal organic framework material, the metal organic framework material layer is adhered to at least one surface of the separator body, and the thickness of the metal organic framework material layer ranges from 15 μm to 75 μm.

Optionally, the water absorption of the water and acid adsorbing battery separator is less than or equal to 800 ppm.

Optionally, the metal organic framework material layer is bonded to the separator body.

Optionally, the acid absorption of the battery composite separator is less than or equal to 1107 ppm.

Optionally, the metal organic framework material is selected from at least one of HKUST-1, MOF-801, MIL-101, MOF-303 and UiO-66.

Optionally, the material of the base film is selected from polyolefins, glass fibers or polyimides.

In another aspect, the embodiment of the present invention also provides a method for preparing a water and acid adsorbing battery separator, comprising the following steps:
(1) mixing the metal organic framework material and a binder in a mass ratio of 5:5 to 9:1 to obtain a slurry;
(2) coating the slurry on the base film, and heating, drying and curing the base film to obtain the separator.

Optionally, the thickness of the slurry coated on the base film ranges from 15 μm to 75 μm.

Optionally, the binder comprises at least one of polyvinylidene fluoride (PVDF) and polytetrafluoroethylene (PTFE).

Optionally, the coating method comprises blade coating, gravure roll coating, dipping, slit coating or spraying.

Optionally, the treatment of heating, drying and curing comprises: drying at 60-80° C. in a forced air oven, and then transferring to a vacuum oven and baking at 40-70° C. for at least 12 hours.

In another aspect, an embodiment of the present invention also provides a water and acid adsorbing electrode plate, comprising an electrode substrate, a metal organic framework material is dispersed on a surface of the electrode substrate, and the electrode substrate comprises a positive electrode plate and/or a negative electrode plate.

In another aspect, an embodiment of the present invention also provides a battery, including the aforementioned water and acid adsorbing battery separator.

In another aspect, an embodiment of the present invention also provides a battery, including the aforementioned water and acid adsorbing electrode plate.

### Beneficial Effects

The present invention adopts a metal organic framework material with a high specific surface area and effective adsorption sites in the pores, and coats it on the battery separator (base film) to prepare a composite separator as a water and acid adsorbing battery separator that can efficiently adsorb impurities such as water/acid in the battery. On the one hand, the water and acid adsorbing battery separator can effectively adsorb impurities such as water and acid in the battery, thereby improving the battery cycling stability; on the other hand, the water and acid adsorbing battery separator can reduce the strict control conditions for water during the battery assembly process, and can realize the direct assembly of lithium batteries in the external environment, thereby simplifying the assembly industry and effectively reducing costs. Furthermore, the water and acid adsorbing battery separator provided in the embodiments of the present invention can also effectively inhibit lithium dendrites and increase the service life of the positive electrode material.

### BRIEF DESCRIPTION OF THE DRAWINGS

FIG. 1 is a photograph of the water and acid adsorbing battery separator prepared in Example 1 of the present invention.

FIG. 2 is a SEM image of the surface morphology of the water and acid adsorbing battery separator prepared in Example 1 of the present invention.

FIG. 3 is a battery cycling performance comparison diagram of Example 1 of the present invention and Comparative Example 1.

FIG. 4 is a diagram comparing the battery cycling performance of Example 2 of the present invention and Comparative Example 2.

FIG. 5 is a diagram comparing the battery rate performance of Example 2 of the present invention and Comparative Example 2.

FIG. 6 is a diagram comparing the battery cycling performance of Example 3 of the present invention and Comparative Example 3 after the NMC622 positive electrode is treated at 30% humidity;

FIG. 7 shows the battery cycling performance of the water and acid adsorbing battery separator prepared in different proportions in the examples of the present invention in 1 M LiPF₆/EC-DMC electrolyte with a water content of 800 ppm.

FIG. 8 shows the battery cycling performance of the water and acid adsorbing battery separator of different thicknesses in the examples of the present invention in 1 M LiPF₆/EC-DMC electrolyte with a water content of 800 ppm.

FIG. 9 is a SEM image of the surface morphology of the Li electrode and NCM622 electrode after 200 cycles of Example 1 of the present invention and Comparative Example 1.

FIG. 10 is a schematic diagram showing the porous structure of MIL-101(Cr) provided by the present invention.

FIG. 11 is a diagram of comparing the battery cycling performance of Example 4 of the present invention and Comparative Example 4.

FIG. 12 is a schematic diagram showing the structure of a water and acid adsorbing battery separator provided by an embodiment of the present invention.

FIG. 13 is a schematic diagram of the structure of another water and acid adsorbing battery separator provided by an embodiment of the present invention.

In the drawings: 1—separator body; 2—metal organic framework material layer.

### DETAILED DESCRIPTION OF THE PREFERRED EMBODIMENTS

As can be seen from the background, the trace amounts of water and acid currently present in the battery have great impact on the battery cycling performance.

Specifically, the electrolyte of a lithium battery is the carrier of ion transmission in the battery. It is generally composed of lithium salts and organic solvents. The electrolyte plays the role of conducting ions between the positive and negative electrodes of the lithium battery, and is the guarantee for lithium-ion (metal) batteries to obtain advantages such as high voltage and high specific energy. Since LiPF₆ has good balance performance with the currently commonly used organic carbonate solvents and shows a high lithium ion conductivity, LiPF₆ is still the main conductive salt for lithium ions. Furthermore, the LiPF₆ electrolyte can passivate the positive electrode current collector (aluminum foil), allowing the battery to operate at a potential higher than 4.2 V vs. Li/Li⁺, which is a necessary condition for achieving high energy density of batteries with nickel-rich layered positive electrode materials.

However, LiPF₆ is highly sensitive to water. When there is trace water in the electrolyte, a series of side reactions will occur. The acidic substances produced, such as highly corrosive hydrofluoric acid (HF), will accelerate the dissolution of the positive electrode transition metal (TM). The dissolved TM cations diffuse to the negative electrode surface, destroying the solid electrolyte interface (SEI), resulting in the capacity decay of the positive electrode material (especially the nickel-rich positive electrode material) and the continuous decrease in the battery cycling performance. Therefore, the entire process of lithium-ion (metal) battery assembly, the preparation of the electrolyte composed of lithium salts and organic solvents, and the drying of the positive and negative electrode active materials need to be operated in an extremely low humidity environment such as a glove box or a drying room to ensure that the battery does not introduce additional moisture. Such strict control of water content requires a lot of cost (including laboratories and industry). Moreover, in industry, LiPF₆ is usually prepared from anhydrous HF (as a fluorination agent and recrystallization solvent). Therefore, no matter what advanced process is used, the extremely trace amounts of water and hydrogen fluoride that are difficult to be absolutely eliminated in the electrolyte (the purchased electrolyte generally controls the water content: <20-30 ppm) also lead to poor battery cycling performance.

To solve the above problems, an embodiment of the present invention provides a water and acid adsorbing battery separator, comprising a base film and a metal organic framework material, wherein the metal organic framework material is dispersed on at least one surface of the base film.

It should be noted that the metal organic framework material is dispersed on at least one surface of the base film, which means that along the thickness direction of the base film, the metal organic framework material can be adhered to one surface or both surfaces of the base film.

The base film is used to carry the metal organic framework material to improve the strength of the water and acid adsorbing battery separator. The material of the base film may be selected from polyolefins, glass fibers or electrospun polyimides.

In one embodiment, the specific surface area of the metal organic framework material is >900 m²/g, wherein the specific surface area is measured by the BET test method, and the test conditions are 80° C. degassing for 12 h and N₂ atmosphere at 77 K. Further, in order to increase the speed of the separator to absorb water and acidic substances, a metal organic framework material with a specific surface area >2400 m²/g can be selected.

The metal organic framework material is of a porous structure, and the pore size of the metal organic framework material may range from 0.92 nm to 3.5 nm. The pore size of the metal organic framework material is calculated based on the specific surface area using the Tikhonov regularization fitting method.

In order to improve the water and acid absorption performance of the water and acid adsorbing battery separator, a metal organic framework material with a high specific surface area and effective adsorption sites (such as empty coordination sites or ionic adsorption sites) in the pores may be selected. In one embodiment, the metal organic framework material may be selected from at least one of HKUST-1, MOF-801, MIL-101, MOF-303 and UiO-66. In order to improve the adsorption performance of the water and acid adsorbing battery separator, in one embodiment, the metal organic framework material may be MIL-101(Cr). MIL-101(Cr) has a higher surface area (2400 m²/g) and unsaturated metal sites. MIL-101 has two types of pores, with pore sizes of 2.14 nm and 3.4 nm, respectively.

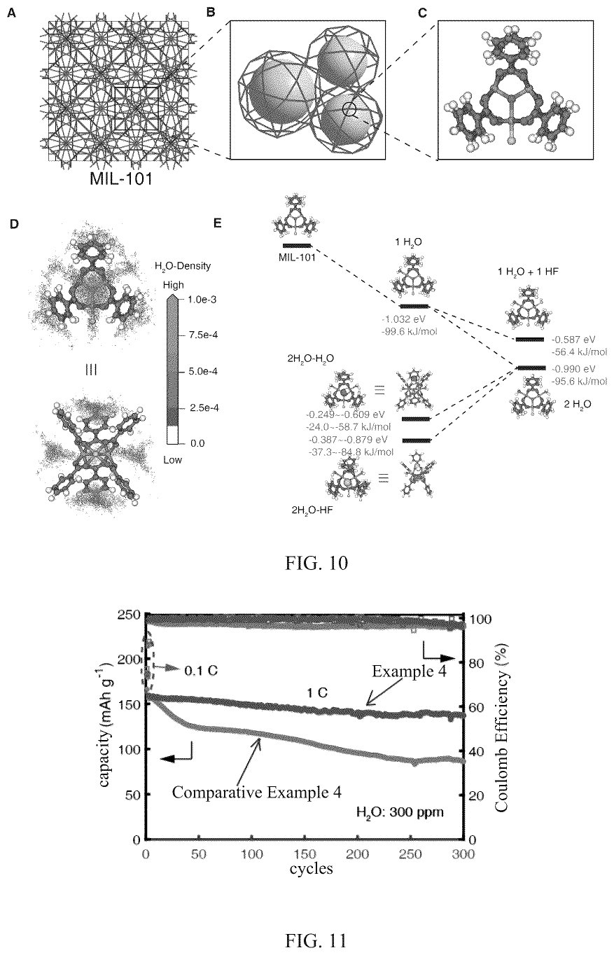

Furthermore, the building blocks of MIL-101(Cr) have strong polarity and are good adsorption sites for water and HF. By selecting metal-organic framework materials with high specific surface area and effective adsorption sites for water and acid, the water and acid adsorbing performance of a water and acid adsorbing battery separators can be effectively improved. The adsorption energy of MIL-101 for H₂O and HF was calculated according to density functional theory (as shown in FIG. 10), where A in FIG. 10 is the unit cell structure of MIL-101(Cr), B is two types of mesopores (spheres represent the internal available volume), C is the MIL-101(Cr) structural unit (Cr metal-building unit, Cr-MBU), and D is the top view and side view of the adsorption sites of Cr-MBU for water. It can be seen that Cr-MBU has a high site for water adsorption. E is the adsorption energy of Cr-MBU for H₂O and HF. The adsorption energy of Cr-MBU for water is as high as −95.6 kJ/mol. Even after absorbing two water molecules, Cr-MBU still exhibits an adsorption energy of −58.7 kJ/mol so as to absorb more water.

The water and acid adsorbing battery separator provided in the embodiment of the present invention can be used in conjunction with an electrolyte with a water content of up to 800 ppm to assemble a battery. In one aspect, the water and acid adsorbing battery separator can effectively absorb impurities such as water and acid in the electrolyte, thereby improving the battery cycling stability. In another aspect, the water and acid adsorbing battery separator can reduce the strict control conditions for water during battery assembly, and can realize the direct assembly of lithium batteries in the external environment, thereby simplifying the assembly industry and effectively reducing costs. Furthermore, the water and acid adsorbing battery separator provided in the embodiment of the present invention can also effectively inhibit lithium dendrites and increase the service life of the positive electrode material.

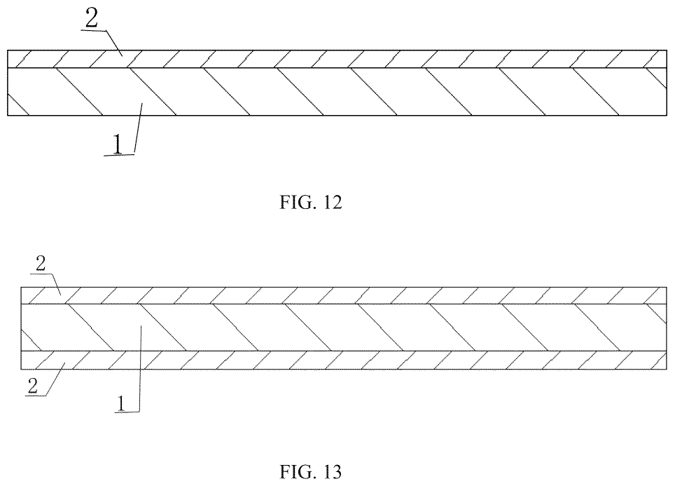

Please refer to FIGS. 12 and 13. FIG. 12 is a structural schematic diagram of a water and acid adsorbing battery separator provided in an embodiment of the present invention; FIG. 13 is a structural schematic diagram of another water and acid adsorbing battery separator provided in an embodiment of the present invention.

Referring to FIGS. 12 and 13, an embodiment of the present invention provides a water and acid adsorbing battery separator, which is a battery composite separator, including a separator body 1 and a metal organic framework material layer 2, wherein the separator body 1 is composed of a base film, the metal organic framework layer 2 is composed of the metal organic framework material, the metal organic framework material layer 2 is adhered to at least one surface of the separator body 1, the thickness of the metal organic framework material layer 2 ranges from 15 μm to 75 μm, and the water absorption of the water and acid adsorbing battery separator is less than or equal to 800 ppm.

It should be noted that the water absorption of the water and acid adsorbing battery separator is less than or equal to 800 ppm, which means that when the water and acid adsorbing battery separator of the present application is assembled into a battery, when the water content in the electrolyte is as high as 800 ppm, the battery can still have stable cycling performance. The electrolyte purchased on the market generally controls the water content: <20-30 ppm. Therefore, the water and acid adsorbing battery separator of the present application can effectively absorb water in the electrolyte, and can reduce the strict control conditions for water in the battery assembly process, and can realize the direct assembly of batteries in the external environment, thereby simplifying the assembly industry and effectively reducing costs.

The water and acid adsorbing battery separator also has acid absorption performance, and the acid absorption of the water and acid adsorbing battery separator is as high as 1107 ppm. That is, when the water and acid adsorbing battery separator of the present application is assembled into a battery, when the acid content (HF and other acidic substances) in the electrolyte is as high as 1107 ppm, the battery can still have stable cycling performance.

It should be noted that the metal organic framework material layer is adhered to at least one surface of the separator body, which means that along the thickness direction of the separator body, the metal organic framework material layer can be adhered to one surface of the separator body (as shown in FIG. 12) or both surfaces of the separator body (as shown in FIG. 13).

Specifically, the thickness of the metal organic framework material layer 2 cannot be too thick or too thin. If the thickness of the metal organic framework material layer is too thin, the water absorption performance is poor. If the thickness of the metal organic framework material layer is too thick, it will also affect the battery performance. Therefore, the thickness of the metal organic framework material layer ranges from 15 μm to 75 μm, specifically, it may be 45 μm, 50 μm, 55 μm, 60 μm, 70 μm, 80 μm, 90 μm, etc.

In order to improve the stability of the metal organic framework material layer 2 adhered to the separator body and to reduce the complexity of the process, in a specific embodiment, the metal organic framework material layer 2 may be bonded to the separator body 1 by an adhesive, and the adhesive can be selected from at least one of PVDF and PTFE. In other embodiments, the metal organic framework material layer can also be adhered to the separator body by other means, such as grafting by a coupling agent, chemical cross-linking, etc.

The separator body is used to carry the organic framework material layer to improve the strength of the water and acid adsorbing battery separator. The separator body may be any one of a polyolefin film, a glass fiber film, and an electrospun polyimide film.

In one embodiment, a metal organic framework material with a specific surface area of >900 m²/g can be selected. Further, in order to increase the rate at which the separator absorbs water and acidic substances, a metal organic framework material with a specific surface area of >2400 m²/g can be selected. Among them, the specific surface area is tested by the BET test method, and the test conditions are degassing at 80° C. for 12 h and testing at 77 K in N₂ atmosphere.

It is easy for those skilled in the art to understand that metal organic framework materials (MOFs) are porous materials and thus have good adsorption properties. In one embodiment, a metal organic framework material with a pore size ranging from 0.92 nm to 3.5 nm can be selected. The pore size of the metal organic framework material is calculated based on the specific surface area using the Tikhonov regularization fitting method.

In order to improve the water and acid adsorbing performance of the water and acid adsorbing battery separator, in a specific embodiment, the material of the metal organic framework material layer 2 can be MIL-101. Taking MIL-101(Cr) as an example, the specific surface area of MIL-101(Cr) is as high as 2400 m²/g. Such a high specific surface area can absorb water and acidic substances quickly, and has two types of pores with different pore sizes, which can store a large amount of water, thereby improving the water and acid adsorbing performance of the battery composite separator. In other embodiments, the material of the metal organic framework material layer may also be selected from at least one of HKUST-1, MOF-801, MOF-303 and UiO-66.

In order to illustrate the process of obtaining a water and acid adsorbing battery separator, an example of a preparation method for preparing a water and acid adsorbing battery separator is provided. It should be noted that the preparation method provided in this application is only used as an example and cannot be understood as limitation of this application.

In one example, a method for preparing a water and acid adsorbing battery separator may comprise the following steps:
(1) mixing a metal organic covalent material and a binder to prepare a slurry;
(2) pouring the slurry onto a commercial polyolefin film and coating it with a doctor blade;
(3) drying the coated film to obtain a water and acid adsorbing battery separator.

The water and acid adsorbing battery separator provided in the embodiment of the present invention has a metal organic framework material layer adhered to the separator body. When the water and acid adsorbing battery separator is assembled into a battery, the metal organic framework material layer of the water and acid adsorbing battery separator may absorb water, acid and other impurities in the battery. Since the thickness of the metal organic framework material layer ranges from 15 μm to 75 μm, it can not only ensure the adsorption effect, but also avoid affecting the battery performance due to the excessive thickness of the separator, thereby improving the battery cycling stability. In another aspect, the water and acid adsorbing battery separator can reduce the strict control conditions for water during the battery assembly process, and can realize the direct assembly of batteries in the external environment, thereby simplifying the assembly industry and effectively reducing costs.

To solve the above problems, the embodiment of the present invention provides a method for preparing a water and acid adsorbing battery separator, comprising the following steps:
(1) mixing a metal organic framework material and a binder in a molar ratio of 5:5 to 9:1 to obtain a slurry;
(2) coating the slurry on a base film, and heating, drying and curing the base film to obtain the separator.

In one embodiment, the specific surface area of the metal organic framework material is >900 m²/g. Further, in order to increase the speed of adsorption of water and acidic substances, a metal organic framework material with a specific surface area of >2400 m²/g may be selected.

The metal organic framework material may be selected from at least one of HKUST-1, MOF-801, MIL-101, MOF-303 and UiO-66.

The coating method comprises blade coating, gravure roll coating, dipping, slit coating or spraying.

The thickness of the slurry coated on the base film cannot be too thick or too thin. If it is too thin, the water and acid absorption effect is not good. If it is too thick, it will also affect the performance of the battery. Therefore, in a specific embodiment, the thickness of the slurry coated on the base film ranges from 15 μm to 75 μm, for example, 20 μm, 25 μm, 30 pm, 40 μm, 50 μm, 60 μm, 70 μm.

The treatment of heating, drying and curing comprises: drying at 60-80° C. in a forced air oven, and then transferring to a vacuum oven at 40-70° C. for at least 12 hours.

The metal organic framework material is of a porous structure, and the pore size of the metal organic framework material may range from 0.92 nm to 3.5 nm. The pore size of the metal organic framework material is calculated according to the specific surface area using the Tikhonov regularization fitting method. Taking MIL-101(Cr) as an example, MIL-101(Cr) has two types of pores, with pore sizes of 2.14 nm and 3.4 nm respectively.

The binder includes at least one of PVDF and PTFE.

The base film is used to carry the metal organic framework material to improve the strength of the water and acid adsorbing battery separator. The material of the base film may be selected from polyolefins, glass fibers or electrospun polyimides.

The present invention adopts a metal organic framework material and coats it on a battery separator to prepare a composite separator that can efficiently absorb impurities such as water/acid in the battery as a water and acid adsorbing battery separator. In one aspect, the water and acid adsorbing battery separator can effectively absorb impurities such as water and acid in the battery, thereby improving the battery cycling stability. In another aspect, the water and acid adsorbing battery separator can reduce the strict control conditions for water during the battery assembly process, and can realize the direct assembly of lithium batteries in the external environment, thereby simplifying the assembly industry and effectively reducing costs.

To solve the above problems, an embodiment of the present invention provides a water and acid adsorbing electrode plate, comprising an electrode substrate, a metal organic framework material dispersed on a surface of the electrode substrate, and the electrode substrate includes a positive electrode plate and/or a negative electrode plate.

The specific surface area of the metal organic framework material is >900 m²/g, and further, the specific surface area of the metal organic framework material is >2400 m²/g.

The pore size of the metal organic framework material ranges from 0.92 nm to 3.5 nm.

The metal organic framework material is selected from at least one of HKUST-1, MOF-801, MIL-101, MOF-303 and UiO-66. Further, in order to improve the adsorption performance of the water and acid adsorbing electrode plate, the metal organic framework material may be MIL-101.

To solve the above problems, an embodiment of the present invention provides a battery, comprising the aforementioned water and acid adsorbing battery separator.

The positive electrode material of the battery may be selected from at least one of lithium cobalt oxide, lithium manganese oxide, lithium nickel oxide, nickel-cobalt-manganese ternary material and lithium-rich layered material.

The negative electrode material of the battery may be selected from at least one of graphite, metallic lithium, silicon carbon, phosphorus carbon, silicon and phosphorus.

The battery provided in the embodiment of the present invention contains the aforementioned water and acid adsorbing battery separator. On the one hand, the water and acid adsorbing battery separator can effectively absorb impurities such as water and acid in the battery electrolyte, thereby improving the battery cycling stability. On the other hand, the water and acid adsorbing battery separator can reduce the strict control conditions for water during the battery assembly process, and can realize the direct assembly of lithium batteries in the external environment, thereby simplifying the assembly industry and effectively reducing costs.

To solve the above problems, an embodiment of the present invention provides a battery, comprising the aforementioned water and acid adsorbing electrode plate.

The battery provided by the embodiment of the present invention contains the aforementioned water and acid adsorbing electrode plate. On the one hand, the water and acid adsorbing battery separator can effectively absorb water, acid and other impurities in the battery, thereby improving the battery cycling stability. On the other hand, the water and acid adsorbing battery separator can reduce the strict control conditions for water in the battery assembly process, and can realize the direct assembly of lithium batteries in the external environment, thereby simplifying the assembly industry and effectively reducing costs.

The battery provided by the embodiment of the present invention contains the aforementioned water and acid adsorbing battery separator. Since a metal organic framework material layer with a porous structure is adhered to the separator body, when the water and acid adsorbing battery separator is assembled into a battery, the metal organic framework material layer of the water and acid adsorbing battery separator can absorb water, acid and other impurities in the electrolyte. Since the thickness of the metal organic framework material layer ranges from 15 μm to 75 μm, it can not only ensure the adsorption effect, but also avoid affecting the battery performance due to the excessive thickness of the separator, thereby improving the battery cycling stability. On the other hand, the water and acid adsorbing battery separator can reduce the strict control conditions for water in the battery assembly process, and can realize the direct assembly of batteries in the external environment, thereby simplifying the assembly industry and effectively reducing costs.

The water and acid adsorbing battery separator and its preparation method, a water and acid adsorbing electrode plate, and a battery of the present invention are further described in details below in combination with specific embodiments and comparative examples.

### EXAMPLE 1

### Preparation of MIL-101(Cr)

5 g of Cr(NO₃)₃·9H₂O and 2.1 g of terephthalic acid were dissolved in 50 mL of deionized water. While being stirred, 1 mL of 40% hydrofluoric acid was added drop-wise. After being ultrasonically vibrated for 30 min, the mixture was transferred to a 100 mL reaction kettle (lined with polytetrafluoroethylene). Then, the reaction was carried out at 220° C. for 8 h. After being cooled to room temperature, the product was centrifugally separated, and then washed multiple times alternately with hot N,N-dimethylformamide (DMF) and absolute ethanol. It was put into a drying oven and dried at 130° C. for 12 h. Thus, 3.1 g of the purified MIL-101(Cr) sample was obtained.

### Preparation of Water and Acid Adsorbing Battery Separator

(1) Preparation of slurry: MIL-101(Cr) and PVDF were mixed at a mass ratio of 7:3, then N-methylpyrrolidone (NMP) was added according to the ratio of 1 g of the mixture to 2 mL of NMP and the mixture was ground uniformly;
(2) The slurry was poured on a commercial polyolefin separator and coated by means of a doctor blade (coating thickness 15 μm);
(3) The separator was transferred to a forced air oven and dried at 60-80° C., and then transferred to a vacuum oven at 40-70° C. for at least 12 hours.

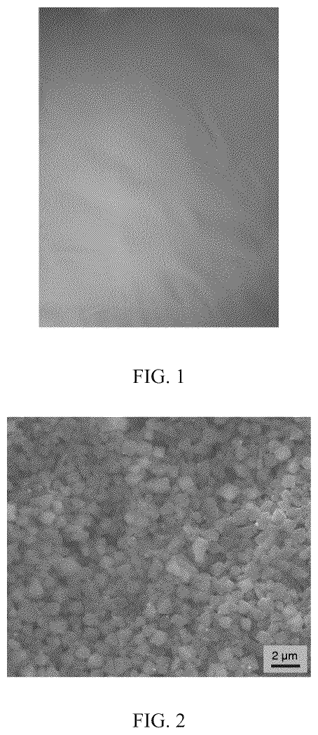

The prepared water and acid adsorbing battery separator is shown in FIG. 1. The water and acid adsorbing battery separator of Example 1 was scanned by electron microscope using Hitachi SU-3800 field emission scanning electron microscope, as shown in FIG. 2. According to FIG. 2, the metal organic framework material is uniformly dispersed on the surface of the water and acid adsorbing battery separator.

### Preparation of Electrolyte

800 ppm of water was added to 1M of LiPF₆ -ethylene carbonate/dimethyl carbonate (EC/DMC) (3/7, v/v) electrolyte to prepare 1 M of LiPF₆/EC-DMC electrolyte with a water content of 800 ppm (the purchased electrolyte generally had a controlled water content: <20-30 ppm).

### Battery Assembly Process

In a glove box, LiNi_{10.6}Mn_{0.2}Co_{0.2}O₂ (NMC) was used as the positive electrode, lithium metal was used as the negative electrode, the water and acid adsorbing battery separator of Example 1 was used as the battery separator, and 1 M of LiPF₆/EC-DMC electrolyte with a water content of 800 ppm was used as the electrolyte to assemble NCM622/Li button cells. Among them, the diameter of the positive electrode plate is 12 mm (active material: 5 mg-10 mg), the diameter of the lithium metal negative electrode plate was 15.4 mm, and the thickness of the lithium metal negative electrode plate was 400 μm.

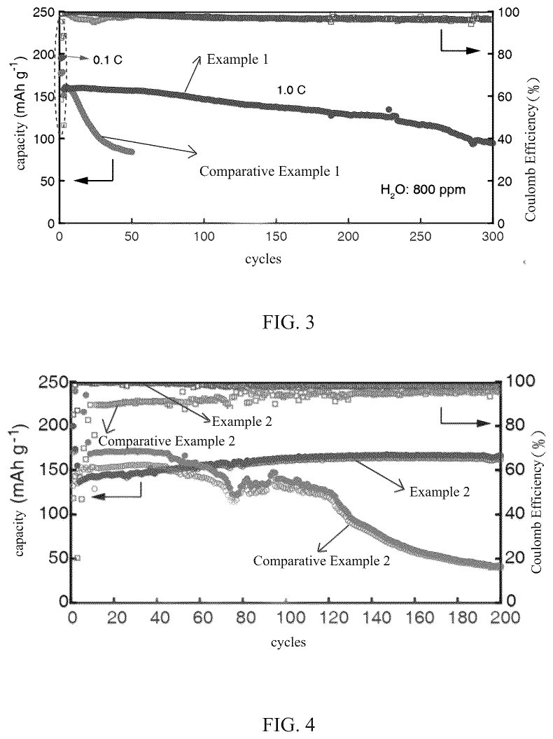

The cycling performance of the battery was tested at 0.1 C (positive electrode: NMC622, negative electrode: Li), and the charge and discharge voltage range was within 2.7-4.3V. After 2 cycles, the cycling test and rate performance test were carried out at 1 C (electrolyte with a water content of 800 ppm). The test results are shown in FIG. 3.

As seen from FIG. 3, when the water content in the electrolyte is 800 ppm (corresponding to 40 times the water content in the normal electrolyte), the capacity of the battery in Comparative Example 1 dropped from 151 mAhg⁻¹ to 84 mAhg⁻¹ after only 50 cycles, and the capacity retention rate was 55%; while for the battery assembled with the water and acid adsorbing battery separator of the present invention, even after 300 cycles, the capacity retention rate still remained at 60%. It shows that the water and acid adsorbing battery separator provided in the example of the present invention can effectively absorb water in the electrolyte, and the battery assembled with the water and acid adsorbing battery separator can achieve stable cycling performance.

Furthermore, the surface morphology of the Li electrodes and NCM622 electrodes of the batteries of Example 1 and Comparative Example 1 after 200 cycles was observed using a Zeiss field emission scanning electron microscope (ZEISS Gemini, 5 kV, Germany), and the test results are shown in FIG. 9. As seen from FIG. 9, after 200cycles, no dendrites appeared on the surface of the Li electrode of Example 1 (Drawing D in FIG. 9), while obvious dendrites appeared on the surface of the battery of Example 1 (Drawing C in FIG. 9). On the positive electrode side of the battery, it can be easily observed that the NMC622 particles of the battery of Comparative Example 1 have a large number of cracks (Drawing A in FIG. 9), while the water and acid adsorbing battery separator of the example of the present invention used in Example 1 can significantly inhibit the cracks (Drawing B in FIG. 9).

### EXAMPLE 2

### Preparation of Acidic Electrolyte

1M of LiPF₆ EC/DMC (3/7, v/v) electrolyte was added with 300 ppm of water, and placed in a forced air oven at 80° C. for 21 days, taken out and measured with the acid content to be 1107 ppm (the purchased electrolyte generally controls the acid content <20 ppm), to prepare the acidic electrolyte.

### Battery Assembly Process

In a glove box, LiNi_{0.6}Mn_{0.2}Co_{0.2}O₂ (NMC) was used as the positive electrode, lithium metal was used as the negative electrode, the water and acid adsorbing battery separator of Example 1 is used as the separator, and the acidic electrolyte of Example 2 is used as the electrolyte to assemble NCM622/Li cells. Among them, the diameter of the positive electrode plate is 12 mm (active material: 5 mg-10 mg), the diameter of the lithium metal negative electrode is 15.4 mm, and the thickness is 400 μm.

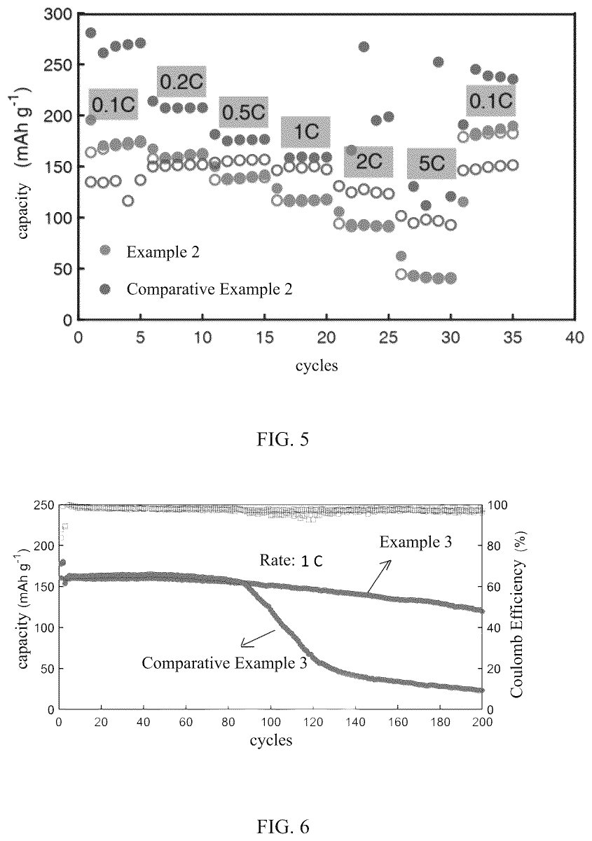

The cycling performance of the battery was tested (positive electrode: NMC622, negative electrode: Li), and the charge and discharge voltage range was within 2.7-4.3V. The cycling test and rate performance test were carried out at 0.5 C (0.1 C for the first two cycles). The test results are shown in FIGS. 4 and 5.

As seen from FIG. 4, when the acid content in the electrolyte is 1107 ppm (corresponding to 55 times the acid content in the normal electrolyte), the battery assembled with the commercial separator of Comparative Example 2 has a large difference in charge and discharge capacity, and the discharge capacity is much lower than the charge capacity. In the first 10 cycles, the coulomb efficiency was less than 60%, and the final coulomb efficiency was only about 90%, indicating that the byproducts of LiPF₆ liquid electrolyte at high temperature greatly damaged the battery. In contrast, the battery assembled with the water and acid adsorbing battery separator of the example of the present invention showed stable cycling performance in 200 cycles, and the coulomb efficiency was as high as 98%.

As seen from FIG. 5, the battery assembled with the water and acid adsorbing battery separator of the example of the present invention has excellent high-current charge and discharge performance at different rates; while the battery assembled with the commercial separator of the comparative example cannot be stably cycled even at 0.1 C.

Combining FIGS. 4 and 5, it can be seen that the water and acid adsorbing battery separator provided in the example of the present invention can effectively absorb the acid in the electrolyte, and the battery comprising the water and acid adsorbing battery separator of the present invention can achieve stable cycling performance.

### EXAMPLE 3

Before assembling the button cells, the NMC622 positive electrode was placed in a constant temperature/humidity box (30° C., 30% relative humidity) for 1 hour, and the battery was assembled in a drying room. After 24 hours, the charge and discharge cycle was started, and the cycling performance of the battery was tested at 1 C. Positive electrode: NMC622, negative electrode: Li, test conditions: 2.7-4.3V, the test results are shown in FIG. 6.

As seen from FIG. 6, the capacity retention rate of the battery after 200 cycles is 75%, and the discharge capacity is 120 mAhg⁻¹, while the performance of the battery assembled with the commercial separator in Comparative Example 3 suddenly decreases after only 85 cycles, and the discharge capacity after 200 cycles is 22.6 mAhg⁻¹, and the capacity retention rate is 14.7%. It shows that the acid adsorbing battery separator provided in the example of the present invention can reduce the strict control conditions for water in the battery assembly process, and can realize the direct assembly of lithium batteries in the external environment, thereby simplifying the assembly industry and effectively reducing costs.

### EXAMPLE 4

The difference between Example 4 and Example 1 lies in the preparation of the electrolyte: 300 ppm of water was added to the 1M LiPF₆ ethylene carbonate/dimethyl carbonate (EC/DMC) (3/7, v/v) electrolyte to obtain a 1M LiPF₆/EC-DMC electrolyte with a water content of 300 ppm (the purchased electrolyte generally had a controlled water content: <20-30 ppm). The rest was the same as Example 1.

The battery cycling performance was tested at 0.1 C (positive electrode: NMC622, negative electrode: Li), and the charge and discharge voltage range was within 2.7-4.3V. After 2 cycles, the cycling test and rate performance test were carried out at 1 C (electrolyte with water content of 300 ppm). The test results are shown in FIG. 11.

As seen from FIG. 11, when the water content in the electrolyte is 300 ppm (corresponding to 15 times the water content in the normal electrolyte), the battery assembled with the water and acid adsorbing battery separator of the present invention has a capacity retention rate of 86% even after 300 cycles. The battery of Comparative Example 4 bas a capacity retention rate of less than 55% under the same cycling conditions.

### EXAMPLE 5

Please refer to Example 1 for the preparation of MIL-101(Cr).

### Preparation of Water and Acid Adsorbing Battery Separator

(1) Preparation of slurry: MIL-101(Cr) and PVDF were mixed in a mass ratio of 5:5, NMP was added at a ratio of 1 g mixture/2 mL N-methylpyrrolidone (NMP) and the mixture was ground uniformly;
(2) The slurry was poured on a commercial polyolefin separator and coated by means of a doctor blade (coating thickness 30 μm);
(3) The separator was transferred to a forced air oven and dried at 60-80° C., and then transferred to a vacuum oven at 40° C.-70° C. and dry it for at least 12 hours.

### Preparation of Electrolyte

800 ppm of water was added to 1M of LiPF₆ EC/DMC (3/7, v/v) electrolyte to prepare 1M of LiPF₆/EC-DMC electrolyte with a water content of 800 ppm.

### Battery Assembly Process

The ternary-material NMC positive electrode plate with the diameter of 12 mm (active material: 5-10 mg), a water and acid adsorbing battery separator, a lithium metal negative electrode (diameter 15.4 mm, thickness 400 pm), 1 M LiPF₆/EC-DMC electrolyte with a water content of 800 ppm.

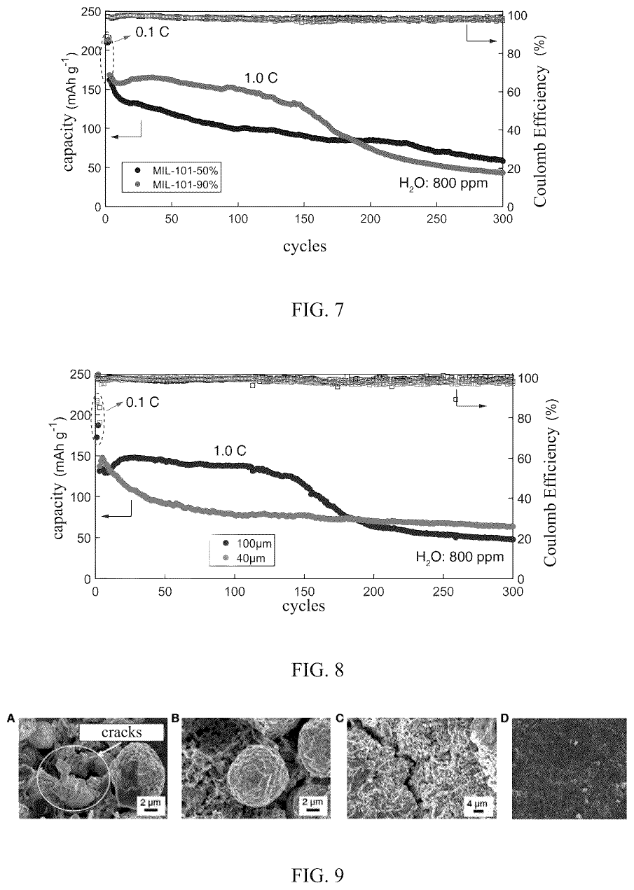

The battery cycling performance was tested (positive electrode: NMC622, negative electrode: Li), the charge and discharge voltage range was within 2.7-4.3V. The cycling test and rate performance test (electrolyte with a water content of 800 ppm) were carried out at 1 C after two cycles at 0.1 C ). The test results are shown in FIG. 7.

### EXAMPLE 6

The mass ratio of MIL-101 and PVDF was changed to a 9:1 ratio, and the rest was the same as Example 4. The battery was subjected to cycling test and rate performance test. The test results are shown in FIG. 7.

As seen from FIG. 7, the battery assembled with water and acid adsorbing battery separators of different proportions can still achieve 300 cycles in the 1 M LiPF₆/EC-DMC electrolyte with a water content of 800 ppm.

### EXAMPLE 7

### Preparation of Electrolyte

800 ppm of water was added to 1M of LiPF₆ EC/DMC (3/7, v/v) electrolyte to prepare 1 M of LiPF₆/EC-DMC electrolyte with a water content of 800 ppm.

### Battery Assembly Process

The ternary-material NMC positive electrode plate with the diameter of 12 mm (active material: 5-10 mg), the water and acid adsorbing battery separator of Example 1 (total thickness 40 μm, in which the coating thickness was 15 μm), the lithium metal negative electrode (diameter 15.4 mm, thickness 400 μm), and the 1 M LiPF₆/EC-DMC electrolyte with a water content of 800 ppm.

The battery cycling performance was tested (positive electrode: NMC622, negative electrode: Li), and the charge and discharge voltage range was within 2.7-4.3V. The cycling test and rate performance test (electrolyte with a water content of 800 ppm) were carried out at 1 C (after two cycles at 0.1 C). The test results are shown in FIG. 8.

### EXAMPLE 8

A water and acid adsorbing battery separator with thickness of 100 μm (total thickness 100 μm, in which the coating thickness was 75 μm) was used, and the rest was the same as Example 6. The battery was subjected to cycling test and rate performance test. The test results are shown in FIG. 8.

As shown in FIG. 8, the batteries were assembled with water and acid adsorbing battery separators of different thicknesses. In the 1 M LiPF₆/EC-DMC electrolyte with a water content of 800 ppm, the battery can still reach 300 cycles.

### Comparative Example 1

The separator adopted a commercial polypropylene separator (model: Celgard2500, thickness 25 μm)

### Battery Assembly Process

NMC electrode plate with a diameter of 12 mm (active material: 5-10 mg), commercial polypropylene separator, lithium metal negative electrode (diameter 15.4 mm, thickness 400 μm), electrolyte of Example 1. The battery cycling performance of the commercial polypropylene separator in 1 M LiPF₆/EC-DMC electrolyte with a water content of 800 ppm was tested (positive electrode: NMC622, negative electrode: Li), charge and discharge voltage range within 2.7-4.3V). The test results are shown in FIG. 3.

### Comparative Example 2

The separator adopted a commercial polypropylene separator (model: Celgard2500, thickness 25 μm)

### Battery Assembly Process

NMC electrode plate with a diameter of 12 mm (active material: 5-10 mg), commercial polypropylene separator, lithium metal negative electrode (diameter 15.4 mm, thickness 400 μm), the acidic electrolyte of Example 3. The battery cycling performance and rate performance of the battery were tested in the acid electrolyte (positive electrode: NMC622, negative electrode: Li), charge and discharge voltage range within 2.7-4.3V). The test results are shown in FIGS. 4-5.

### Comparative Example 3

The separator adopted a commercial polypropylene separator (model: Celgard2500, thickness 25 μm), and the rest was the same as Example 3. The test results are shown in FIG. 6.

### Comparative Example 4

The separator adopted a commercial polypropylene separator (model: Celgard2500, thickness 25 μm), and the rest was the same as Example 4. The test results are shown in FIG. 11.

The technical features of the above-mentioned embodiments can be combined arbitrarily. In order to make the description concise, all possible combinations of the technical features in the above-mentioned embodiments are not described. However, as long as there is no contradiction in the combination of these technical features, they should be considered as the scope of this specification.

The above-mentioned examples only illustrate several embodiments of the present invention, and the description thereof is relatively specific and detailed, but it cannot be understood as a limitation on the scope of the invention patent. It should be pointed out that for ordinary technicians in this field, several deformations and improvements can be made without departing from the concept of the present invention, which all belong to the protection scope of the present invention. Therefore, the protection scope of the patent of the present invention shall be based on the adhered claims.
1. A battery composite separator, characterized by comprising a separator body and a metal organic framework material layer, the metal organic framework material layer is adhered to at least one surface of the separator body, the thickness of the metal organic framework material layer ranges from 15 μm to 75 μm, and the water absorption of the battery composite separator is less than or equal to 800 ppm.
2. The battery composite separator according to claim 1, wherein the metal organic framework material layer is bonded to the separator body.
3. The battery composite separator according to claim 1, wherein the specific surface area of the metal organic framework material layer is greater than or equal to 900 m²/g.
4. The battery composite separator according to claim 3, wherein the specific surface area of the metal organic framework material layer is greater than or equal to 2400 m²/g
5. The battery composite separator according to claim 3, wherein the metal organic framework material layer is of a porous structure with a pore size range of 0.92-3.5 nm.
6. The battery composite separator according to claim 1, wherein the material of the metal organic framework material layer is selected from at least one of HKUST-1, MOF-801, MIL-101, MOF-303 and UiO-66.
7. The battery composite separator according to any one of claims 1-6, wherein the separator body is any one of a polyolefin membrane, a glass fiber membrane and an electrospun polyimide membrane.
8. The battery composite separator according to any one of claims 1-6, wherein the acid absorption of the battery composite separator is less than or equal to 1107 ppm.
9. A battery, characterized by comprising a battery composite separator according to any one of claims 1-8.

Although the embodiments of the present invention are disclosed above, the present invention is not limited thereto. Any person skilled in the art can make various changes and modifications without departing from the spirit and scope of the present invention, so the scope of protection of the present invention shall be determined by the scope defined in the claims.

1. A water and acid adsorbing battery separator, comprising a base film and a metal organic framework material, wherein the metal organic framework material is dispersed on at least one surface of the base film.

2. The water and acid adsorbing battery separator according to claim 1, wherein the specific surface area of the metal organic framework material is >900 m²/g.

3. The water and acid adsorbing battery separator according to claim 2, wherein the specific surface area of the metal organic framework material is >2400 m²/g.

4. The water and acid adsorbing battery separator according to claim 2, wherein the pore size of the metal organic framework material ranges from 0.92 nm to 3.5 nm.

5. The water and acid adsorbing battery separator according to claim 1, comprising a separator body and a metal organic framework material layer, wherein the separator body is composed of the base film, the metal organic framework layer is composed of the metal organic framework material, the metal organic framework material layer is adhered to at least one surface of the separator body, and the thickness of the metal organic framework material layer ranges from 15 μm to 75 μm.

6. The water and acid adsorbing battery separator according to claim 5, wherein the water absorption of the water and acid adsorbing battery separator is less than or equal to 800 ppm.

7. The water and acid adsorbing battery separator according to claim 5, wherein the metal organic framework material layer is bonded to the separator body.

8. The water and acid adsorbing battery separator according to claim 5, wherein the acid absorption of the battery composite separator is less than or equal to 1107 ppm.

9. The water and acid adsorbing battery separator according to claim 5, wherein the metal organic framework layer is a porous structure.

10. The water and acid adsorbing battery separator according to claim 1, wherein the metal organic framework material is selected from at least one of HKUST-1, MOF-801, MIL-101, MOF-303 and UiO-66.

11. The water and acid adsorbing battery separator according to claim 1, wherein the material of the base film is selected from polyolefins, glass fibers or polyimides.

12. A method for preparing a water and acid adsorbing battery separator according claim 1, comprising the following steps:
(1) mixing the metal organic framework material and a binder in a mass ratio of 5:5 to 9:1 to obtain a slurry;
(2) coating the slurry on the base film, and heating, drying and curing the base film to obtain the separator.

13. The method for preparing a water and acid adsorbing battery separator according to claim 12, wherein the thickness of the slurry coated on the base film ranges from 15 μm to 75 μm.

14. The method for preparing a water and acid adsorbing battery separator according to claim 12, wherein the binder comprises at least one of polyvinylidene fluoride (PVDF) and polytetrafluoroethylene (PTFE).

15. The method for preparing a water and acid adsorbing battery separator according to claim 12, wherein the coating method comprises blade coating, gravure roll coating, dipping, slit coating or spraying.

16. The method for preparing a water and acid adsorbing battery separator according to claim 12, wherein the treatment of heating, drying and curing comprises: drying at 60-80° C. in a forced air oven, and then transferring to a vacuum oven and baking at 40-70° C. for at least 12 hours.

17. A water and acid adsorbing electrode plate, comprising an electrode substrate, a metal organic framework material is dispersed on a surface of the electrode substrate, and the electrode substrate comprises a positive electrode plate and/or a negative electrode plate.

18. A battery, comprising a water and acid adsorbing battery separator according to claim 1.

19. A battery, comprising a water and acid adsorbing electrode plate as claimed in claim 17.
